(19) United States
(12) Patent Application Publication
(10) Pub. No.: US 2008/0161483 A1
(43) Pub. Date: Jul. 3, 2008

(54) Process For the Preparation of Cross-Linked Pbt Particles

(76) Inventor: Thilo Kind, Konigstein (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/793,744

(22) PCT Filed: Dec. 21, 2005
(86) PCT No.: PCT/EP2005/056997

§ 371 Date: Jun. 21, 2007

(30) Foreign Application Priority Data
Dec. 21, 2004 (EP) 04106807.3

(51) Int. Cl. C08L 31/08; B29C 35/08

(52) U.S. Cl. 524/556; 264/473; 264/477

(57) ABSTRACT

The present invention relates to a process for the preparation of discrete particles prepared from a cross-linkable PBT, at least one additive and/or at least one colorant, comprising the steps of mixing together the components, extruding the material, cooling and pelletizing the material, cross-linking the pellets using gamma radiation, electron beam radiation, or heating in an oven, and optionally grinding into particles with an average particle size between 1 and 1000 μm.

The present invention further relates to the use of said cross-linked PBT particles for making a polychromatic article which comprises a transparent or translucent thermoplastic material having said cross-linked PBT particles uniformly dispersed therein.

The present invention relates to a process for the preparation of discrete particles prepared from a cross-linkable PBT, at least one additive and/or at least one colorant, comprising the steps of mixing together the components, extruding the material, cooling and pelletizing the material, cross-linking the pellets using gamma radiation, electron beam radiation, or heating in an oven, and optionally grinding the pellets into particles with an average particle size between 1 and 1000 μm.

The present invention further relates to the use of said cross-linked PBT particles for making a polychromatic article which comprises a transparent or translucent thermoplastic material having said cross-linked PBT particles uniformly dispersed therein.

JP2068374 discloses a colorant for making a spotted pattern and/or flowing water pattern by blending a thermoplastic resin or elastomer to be crosslinked with a dye or pigment and with an organic peroxide. The thermoplastic resin or elastomer (e.g. polyethylene) is blended with a dye or a pigment and crosslinked with an organic peroxide (e.g. dicumyl peroxide or tributylbenzyl peroxide). In a further step, up to 5% by weight of the (partially) crosslinked blend is introduced into an ordinary thermoplastic resin, which is free from crosslinking reactivity, and a molded article with swirls is formed. A problem of this process is the use of peroxides, which is difficult in dosing and critical due to safety and health reasons and which therefore is avoided in industry, if possible.

EP 0 733 080 B1 discloses a polychromatic article provided by a plastics composition which comprises a transparent or translucent thermoplastic material having a colorant uniformly dispersed therein, characterized in that the colorant comprises a blend of discrete particles at least 90% of which have a minimum dimension in the range 5 to 100 μm and a maximum dimension of no more than 0.5 mm, said particles being of natural or synthetic organic polymer which is compatible with the thermoplastic material, and the plastics composition containing 0.1 to 8% by weight of the blend of said polymer particles based on the weight of the plastics composition. It is further described that the particles can be of cross-linked polymer. The polymers disclosed are cellulose, acrylonitrile polymer or copolymer, polyamide and unsaturated polyester. EP 0 733 080 B1 however is silent on the cross-linking process and on the properties of the crosslinked particles. A problem of this process is the difficulty to form pellets or similar sized particles starting from the proposed polymers, which are often not suitable for grinding.

EP-A-0 604 074 discloses blends of a relatively low molecular weight polybutylene terephthalate resin, a relatively high molecular weight polyester resin and an effective amount of certain phophorous-containing compounds and a process for stabilizing the melt viscosity of a thermoplastic resin blend comprising a relatively low molecular weight polybutylene terephthalate resin, a relatively high molecular weight polyester resin, said process comprising adding to said blend an effective amount of certain phophorous-containing compounds. The process can comprise the steps of blending the ingredients in powdery or granular form, extruding the blend and comminuting into pellets. EP-A-0 604 074 however is silent on the cross-linking process and on the properties of the crosslinked particles.

Different crosslinking concepts have been tested, but do not lead to satisfactory results: For example crosslinking of epoxy resins would require costly chemical engineering solutions. Crosslinking of polyethylene with radiation is incomplete even at high radiation dosis. Thereby the particles stay not discrete in application and lead to undesired swirl effects. Silan crosslinking is generally working well, but leads to significant methanol emission during and after extrusion, which is way to high with regard to accepted exposure levels.

Surprisingly it has now been found, that discrete particles prepared from a cross-linkable PBT (polybutylene terephthalate) by a specific new process, are suitable for grinding and are particularly suitable to manufacture polychromatic articles.

The present invention therefore relates to a process for the preparation of discrete particles prepared from a cross-linkable PBT, at least one additive and/or at least one colorant, comprising the following steps

1. mixing together the components;

2. extruding the material to obtain a homogeneous blend of all the materials and to disperse colorants and/or additives;

3. cooling and pelletizing the material;

4. cross-linking the pellets using gamma radiation, electron beam radiation, or heating in an oven;

5. optionally grinding the pellets into particles with an average particle size between 0.1 and 1000 μm.

The cross-linking of the pellets is preferably carried out by using gamma radiation of at least 300 kGy, electron beam radiation of at least 300 kGy, or heating in an oven to 200° C. for at least 24 h.

The following components are used in the process:
cross-linkable PBT at a loading between 10 and 99.9% by weight, preferably between 30 and 50% by weight;
an additive or additives that will increase the overall hardness and brittleness of the final product, in particular to improve grinding properties of the pellets, at a loading between 1 and 90% by weight, preferably between 10 and 50% by weight; and/or
a colorant or colorants at a loading between 0.1 and 20% by weight, preferably between 1 and 10% by weight;
   the components in the mixture adding up to 100%.

Cross-linkable PBT is a polybutylene terephthalate (PBT) wherein a cross-linkable portion is built into the molecular chain of the PBT. The preferred cross-linkable PBT is a special type of PBT currently only manufactured by Degussa (which is available under the tradename Vestodur® ZD 9411). The material composition is proprietary. Today this material is typically used for injection molding of electronic parts such as connectors.

Additives that will increase the overall hardness and brittleness of the final product are selected from inorganic fillers such as BaSO₄, talc, TiO₂ or calcium carbonate. Care has to be taken, that the additive does not have a negative effect on the cross-linking. For example BaSO₄ absorbs gamma radiation and would thus hinder the cross-linking process, when using gamma radiation. However, other methods for cross-linking (electron beam radiation or heating in an oven) work with BaSO₄. The preferred additive is calcium carbonate, since it is readily available, easy to process, and does not have a negative effect on cross-linking, regardless of the cross-linking method employed. For the process a single additive or several additives may be used, preferably however only one additive is used.

Basically all types of organic and inorganic colorants, in particular organic and inorganic pigments are suitable for the process, as long as they are heat-stable enough for being processed into PBT, which translates into a minimum heat stability of 250° C. This rules out the azo type and diaryl type pigments. Moreover some pigments may change their color during the cross-linking process, depending on the method used. Preferred colorants are organic and inorganic pigments. Most preferred are inorganic pigments such as carbon black TiO₂, and mixed metal oxides, as well as phthalocyanine type and perylene type organic pigments and other high end organic pigments. In another aspect of the invention, heat stable organic dyes which are suitable for PBT can be used as colorants as well. For the process a single colorant or several colorants may be use, preferably however only one colorant is used. In another preferred aspect at least one additive and at least one colorant are used, most preferably one additive and one colorant.

More preferably, the invention relates to a process for the preparation of discrete particles prepared from a cross-linkable PBT, at least one additive and/or at least one pigment, comprising the following steps

1. mixing together the components in a high speed mixing equipment (e.g. Labtech high speed mixer, preferred mixing time: 2 minutes) or separately feeding the components into an extruder using loss-in-weight feeders;

2. extruding the material through a twin screw extruder (preferably a co-rotating twin screw extruder), to obtain a homogeneous blend of all the materials and to disperse pigments and/or additives (with a preferred temperature profile from 200 to 250° C.); the material is extruded through a strand die;

3. cooling the material in a water bath and strand pelletizing or under-water pelletizing;

4. cross-linking the pellets using electron beam radiation of at least 300 kGy, preferably at least 350 kGy;

5. grinding the pellets into particles with an average particle size between 0.1 and 1000 μm, preferably between either 5 and 30 μm or 50 and 250 μm or 500 and 1000 μm.

6. optionally classifying the grinded particles into discrete size classes (e.g. <50 μm, 50-100 μm, 100-200 μm, 200-500 μm).

The classified particles of a certain size class have a narrower size distribution than the initial grinded particles, which can lead to advantages in the final application, such as special structural effects or special impression of color strength. In a further embodiment a mix of particles with different average particle sizes but each with narrow size distribution can be used.

The present invention further relates to the use of cross-linked PBT particles as obtained by the above process, for making a polychromatic article which comprises a transparent or translucent thermoplastic material having said cross-linked PBT particles uniformly dispersed therein.

The cross-linked PBT particles having a maximum dimension of no more than 1000 μm and a minimum dimension of not less than 1 μm and preferably at least 90% of which have a minimum dimension in the range of 5 to 100 μm, are mixed with a transparent or translucent thermoplastic material, at a ratio of from 0.01 to 10% by weight, preferably from 0.1 to 5% by weight, of said cross-linked PBT particles based on the weight of the plastics composition. The incorporation of the particles into the transparent or translucent thermoplastic material (thermoplastic resin) can also be done by the use of a concentrate (masterbatch). For that, the particles are first incorporated into a carrier system compatible with the thermoplastic resin. Typical loading of particles in the carrier system are between 1 to 80%. The carrier is melted in an extruder and the particles are dispersed therein. The carrier is cooled and pelletized. The pellets are than added to the thermoplastic resin in a concentration, so that the desired particle concentration in the thermoplastic resin is reached.

The transparent or translucent thermoplastic material is preferably selected from polyethylene (PE), polypropylene (PP), polystyrene (PS), styrene acrylonitrile copolymer (SAN), acrylonitrile-butadiene-styrene block copolymer (ABS), polyvinylchloride (PVC), polycarbonate (PC), polyethylene terephthalate (PET), polyamide (PA), polymethylmethacrylate (PMMA), polyoxymethylene (POM), ethylene vinyl acetate (EVA).

### EXAMPLES

### Example 1

| | | | % by |
|---|---|---|---|
| Component | Type | Tradename | weight |
| Cross-linkable PBT | | Vestodur ® ZD 9411 | 38% |
| Additive | calcium carbonate | Microcarb ® | 60% |
| Pigment | phthalocyanine | Heliogenblau ® | 2% |
| | | K 6902 | |

Vestodur ® is a Trademark of Degussa, Germany
Microcarb ® is a Trademark of Omya, Switzerland
Heliogenblau ® is a Trademark of BASF, Germany

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

The cross-linked pellets obtained in step 4 were fully cross-linked or cross-linked to a high degree and were easily grindable. In one trial, the grinding was carried out to obtain a size distribution as follows: d₅₀=200 μm, d₉₀=350 μm

In another trial, the grinding was carried out to obtain, after a classifying step, a size distribution in four different particle classes as follows:

d₅₀ (1)=50 μm, d₅₀ (1)=80 μm, d₅₀ (1)=150 μm, d₅₀ (4)=250 μm

Thereby each of the four particle classes had a very narrow size distribution.

### Example 2

| | | | % by |
|---|---|---|---|
| Component | Type | Tradename | weight |
| Cross-linkable PBT | | Vestodur ® ZD 9411 | 38% |
| Additive | calcium carbonate | Microcarb ® | 60% |
| Pigment | phthalocyanine | Heliogenblau ® | 2% |
| | | K 6902 | |

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using gamma radiation of 320 kGy;

5. grinding the pellets into particles with an average particle size from 50 to 500 μm.

### Example 3

| | | | % by |
|---|---|---|---|
| Component | Type | Tradename | weight |
| Cross-linkable PBT | | Vestodur ® ZD 9411 | 38% |
| Additive | calcium carbonate | Microcarb ® | 60% |
| Pigment | phthalocyanine | Heliogenblau ® | 2% |
| | | K 6902 | |

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using heating in an oven at 200° C. for 24 hours;

5. grinding the pellets into particles with an average particle size from 50 to 500 μm.

### Example 4

| | | | % |
|---|---|---|---|
| Component | Type | Tradename | by weight |
| Cross-linkable PBT | | Vestodur ® ZD 9411 | 98% |
| Pigment | phthalocyanine | Heliogenblau ® | 2% |
| | | K 6902 | |

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Example 5

| | | | % |
|---|---|---|---|
| Component | Type | Tradename | by weight |
| Cross-linkable PBT | | Vestodur ® ZD 9411 | 98% |
| Pigment | phthalocyanine | Heliogenblau ® | 2% |
| | | K 6902 | |

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using gamma radiation of 320 kGy;

5. grinding the pellets into particles with an average particle size from 50 to 500 μm.

### Example 6

| | | | % |
|---|---|---|---|
| Component | Type | Tradename | by weight |
| Cross-linkable PBT | | Vestodur ® ZD 9411 | 98% |
| Pigment | phthalocyanine | Heliogenblau ® | 2% |
| | | K 6902 | |

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using heating in an oven at 200° C. for 24 hours;

5. grinding the pellets into particles with an average particle size from 50 to 500 μm.

### Example 7

| | | | % |
|---|---|---|---|
| Component | Type | Tradename | by weight |
| Cross-linkable PBT | | Vestodur ® ZD 9411 | 35% |
| Additive | BaSO₄ | | 60% |
| Pigment | phthalocyanine | Heliogenblau ® | 5% |
| | | K 6902 | |

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Example 8

| | | | % by |
|---|---|---|---|
| Component | Type | Tradename | weight |
| Cross-linkable PBT | | Vestodur ® ZD 9411 | 35% |
| Additive | calcium carbonate | Microcarb ® | 60% |
| Pigment | phthalocyanine | Heliogengrün ® | 5% |
| | | K 8730 | |

Heliogengrün ® is a Trademark of BASF, Germany

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Example 9

| | | | % by |
|---|---|---|---|
| Component | Type | Tradename | weight |
| Cross-linkable PBT | | Vestodur ® ZD 9411 | 35% |
| Additive | calcium carbonate | Microcarb ® | 60% |
| Pigment | perylene | PV Fast ® Red B | 5% |

PV Fast ® is a Trademark of Clariant, Switzerland

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Example 10

| | | | % by |
|---|---|---|---|
| Component | Type | Tradename | weight |
| Cross-linkable PBT | | Vestodur ® ZD 9411 | 35% |
| Additive | calcium carbonate | Microcarb ® | 60% |
| Pigment | benzimidazolone | PV Fast ® Yellow HG | 5% |

PV Fast ® is a Trademark of Clariant, Switzerland

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Example 11

| | | | % by |
|---|---|---|---|
| Component | Type | Tradename | weight |
| Cross-linkable PBT | | Vestodur ® ZD 9411 | 35% |
| Additive | calcium carbonate | Microcarb ® | 60% |
| Pigment | carbon black | C.I. Pigment Black 7 | 5% |

(as carbon black a C.I. Pigment Black 7 from Cabot Corporation, US was used)

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Example 12

| Component | Type | Tradename | % by weight |
|---|---|---|---|
| Cross-linkable PBT | | Vestodur ® ZD 9411 | 90% |
| Pigment | titan dioxide | TiO₂ CL2220 | 10% |

(as TiO₂ a CL 2220 type from Kronos, US was used)

The process was run as follows:

1. mixing together the components in a Labtech high speed mixer for 2 minutes;

2. extruding the material through a twin screw extruder, to obtain a homogeneous blend of all the materials and to disperse pigments and additives at a temperature profile from 200 to 250° C.; the material was extruded through a strand die;

3. cooling the material in a water bath and strand pelletizing;

4. cross-linking the pellets using electron beam radiation of 350 kGy;

5. grinding the pellets into particles with an average particle size from 50 to 500 μm.

### Application Example

1 kg GPS pellets (GPS is an injection molding grade polystyrene) were mixed by hand in a polyethylene bag with 1 g of paraffin oil. After 1 minute of mixing, 100 g of blue particles prepared according to example 1 with a size distribution of d₅₀=200 μm and d₉₀=350 μm were added and thoroughly mixed with the GPS pellets. The mixture was then used in an injection molding machine to mold test chips. The resulting chips were of blue color, but not the flat coloration typically known of plastics; the chips rather displayed “depth” causing the impression of a textured surface, as the particles stayed as discrete particles in the matrix.

1. A process for the preparation of particles prepared from a cross-linkable polybutylene terephthalate, at least one additive, at least one colorant or both, comprising the steps of
mixing together the cross-linkable polybutylene terephthalate, the at least one additive, the at least one colorant or both to form mixture;
extruding the mixture,
cooling and pelletizing the mixture to form pellets, and
cross-linking the pellets using gamma radiation, electron beam radiation, or heating in an oven.

2. A process according to claim 1, wherein the cross-linkable polybutylene terephthalate is present in an amount between 10 and 99.9% by weight, wherein at least one of the at least one additive is present in an amount between 1 and 90% by weight or the at least one colorant is present in an amount between 0.1 and 20% by weight, the components in the mixture adding up to 100%, comprising the following steps
mixing together the mixture;
extruding the mixture to obtain a homogeneous blend of the mixture and to disperse at least one of the at least one additive or at least one colorant;
cooling and pelletizing the mixture to form pellets;
cross-linking the pellets using gamma radiation, electron beam radiation, or heating in an oven; and
grinding the pellets into particles, wherein the particles have an average particle size between 0.1 and 1000 μm.

3. A process according to claim 2, further comprising the step of
fractionizing the particles into discrete size classes in order to achieve narrower particle size distributions.

4. A process according to claim 1,
wherein
the at least one additive is an inorganic filler, and
the at least one colorant is an organic or inorganic pigment with a minimum heat stability of 250° C.

5. A process according to claim 1, wherein
the mixing step further comprises mixing the mixture in a high speed mixing equipment or separately feeding the components into an extruder using loss-in-weight feeders;
the extruding step further comprises extruding the mixture through a twin screw extruder, to obtain a homogeneous blend of the mixture and to the at least one colorant, the at least one additive, or both, and, wherein the mixture is extruded through a strand die;
wherein the cooling step further comprises cooling the mixture in a water bath and strand pelletizing or under-water pelletizing the mixture;
wherein the cross-linking step further comprises cross-linking the pellets using electron beam radiation of at least 300 kGy; and
grinding the pellets into particles, wherein the particles have an average particle size between 0.1 and 1000 μm.

6. A process according to claim 2, wherein the grinding step further comprises grinding the particles are ground to have a maximum dimension of no more than 1000 μm and a minimum dimension of not less than 1 μm and at least 90% have a minimum dimension in the range of 5 to 100 μm.

7. A polychromatic article having a transparent or translucent thermoplastic material comprising particles as claimed in claim 13.

8. The polychromatic article as claimed in claim 7, wherein the particles are mixed with a transparent or translucent thermoplastic material, at a ratio of from 0.01 to 10% by weight, based on the weight of the polychromatic article.

9. A process for producing a polychromatic article according to claim 7, comprising the steps of incorporating the particles into a carrier system compatible with the transparent or translucent thermoplastic material at a loading of particles in the carrier system between 1 to 80%;
melting the carrier in an extruder and dispersing the particles in the carrier;
cooling and pelletizing the carrier system to form pellets; and
adding the pellets to the transparent or translucent thermoplastic material, wherein the concentration of the cross-linked particles in the thermoplastic material is from 0.01 to 10% by weight, based on the weight of the thermoplastic material.

10. The polychromatic article according to claim 7, wherein the transparent or translucent thermoplastic material is selected from the group consisting of polyethylene (PE), polypropylene (PP), polystyrene (PS), styrene acrylonitrile copolymer (SAN), acrylonitrile-butadiene-styrene block copolymer (ABS), polyvinylchloride (PVC), polycarbonate (PC), polyethylene terephthalate (PET), polyamide (PA), polymethylmethacrylate (PMMA), polyoxymethylene (POM) and ethylene vinyl acetate (EVA)

11. A process according to claim 4, wherein the at least one inorganic filler is selected from the group consisting of BaSO₄, talc, TiO₂ or calcium carbonate.

12. A process according to claim 4, wherein the at least one colorant is selected from the group consisting of carbon black, TiO₂, phthalo type pigments, perylene type pigments and other high end organic pigments or dyes.

13. Particles made in accordance with the process of claim 1.

14. The process according to claim 9, wherein the particles are present in an amount of from 0.1 to 5% by weight based on the weight of the thermoplastic material.
